(19) United States
(12) Patent Application Publication
(10) Pub. No.: US 2009/0177515 A1
(43) Pub. Date: Jul. 9, 2009

(54) System and method for prioritizing the transformation activities to optimize the resulting infrastructure improvements

(76) Inventors: Lawrence Rea Redd, Fort Collins, CO (US); Joseph George McCathy, JR., Fort Collins, CO (US)

Correspondence Address: LAWRENCE REA REDD, 5302 Golden Willow Dr, Fort Collins, CO, 80528, US

(21) Appl. No.: 12/319,174

(22) Filed: Jan. 2, 2009

Related U.S. Application Data
(60) Provisional application No. 61/010,295, filed on Jan. 7, 2008.

(51) Int. Cl. G06Q 10/00

(52) U.S. Cl. 705/8; 705/7

(57) ABSTRACT

The present invention provides a variety of aspects, which may be combined in different ways to present embodiments of an easy-to-use, straightforward method and apparatus for performing interactive optimization analysis on different classes and subclasses of infrastructure articles by allowing a user to modify different parameters (such as inflation, revenue amounts, budget allocations, etc.) that affect the amount of funding available to perform improvement activities on each of a plurality classes of infrastructure articles, and to determine the expected results, in order to prioritize the said transformation activities so as to optimize the impacts of the improvement transformation activities on the global set of infrastructure articles.

### CROSS REFERENCE TO RELATED APPLICATIONS

This application claims the benefit of U.S. Provisional Patent Application Ser. No. 61/010,295, filed Jan. 7, 2008, by Lawrence Rea Redd, present inventor, which is hereby incorporated by reference.

### BACKGROUND

The present invention generally relates to altered municipal and other infrastructure components and collectives that are improved by a structured analytical approach for prioritizing transformation activities and associated funding across classes of infrastructure articles to result in an optimized use of the funding to perform the most favorable set of improvement activities on the physical infrastructure articles, resulting in an optimum level of infrastructure condition, and more specifically the altered components and collectives as well as a method and an apparatus for identifying a most favorable set of infrastructure transformation activities to perform the optimization of infrastructure condition improvement, given fiscal resource constraints and funding choices.

Simultaneously considering the priorities of transformation activities on multiple classes of infrastructure articles presents a major challenge. With limited funding, the decisions of how to allocate the funding to optimize the benefits “on the ground” require a sound process and proper tools. Decision makers need an understandable, easy-to-use means to weigh the inevitable trade-offs between resources spent on different classes of infrastructure articles, and the anticipated improvements in the condition of those infrastructure articles, to present those trade-offs to stakeholders, and then to communicate the decisions to those who will implement the decisions, optimizing the improvements on the physical infrastructure articles.

As background, the following references involve aspects that have been pursued, however, none provides the advantageous combination and functionalities of the present system: U.S. Pat. Nos. 7,072,863, 7,337,137, 7,469,228 and 6,292,830; US Patent Application Publications Nos. 20050187847, 20050187844, 20050187848, 20050033679, 20080183638, 20040030628, 20060247798, 20070299758, and 20060271210. Some existing practices may employ established analytical models to prioritize transformation activities within each class of infrastructure articles. These prioritized lists of infrastructure transformational activities are often developed based on the funding available for improving the condition of that class of infrastructure articles.

However, decision makers want and need to identify the optimal set of transformational activities and their associated funding across the classes of infrastructure articles in order to globally optimize the improvements to the condition of the infrastructure articles given the fiscal and other constraints. Thus, decision makers are faced with current approaches and tools that fall short in many areas.

Some existing approaches present several disadvantages or shortcomings including:

(a) Manually prioritizing infrastructure transformation activities (and the associated work budget) across infrastructure articles cannot take into account all the different possibilities because of the sheer number of parameters and permutations to consider, such as the incremental benefit/cost ratios for each class and each subclass of infrastructure articles, affects of changes to funding levels to each class and each subclass, etc.

(b) Decision makers are often unable to consider the effects of external variables such as inflation—which may be not be the same for all the different classes of infrastructure articles—during the prioritization and optimization analysis, and ultimately how inflation affects the level of improvement to the infrastructure.

(c) Trying to consider the effects of other changes, such as additional funding on the prioritization and optimization analysis, and on ultimate level of improvement to the infrastructure, renders the problem even more complex.

(d) While decision makers may sometimes anticipate the general effect of moving funding from one class of infrastructure articles—and therefore decreasing the amount of transformation activities that can be performed for that infrastructure class—to another infrastructure class—and therefore increasing the amount of transformation activities that can be performed in that second infrastructure class, they are often unable to determine whether or not each change in funding allocation would ultimately result in a better global improvement to the overall infrastructure.

(e) An approach and tool should be able to allow the user to examine the impacts of funding decisions on different, perhaps orthogonal subclasses of the infrastructure articles; effectively allowing the user to slice the data differently, depending on how the infrastructure makeup needs to be viewed.

(f) The realities of transformation projects are that they can be quite significant in scope, with correspondingly large incremental amounts of funding. Users need tools that are able to model a set of infrastructure articles capable of handling such large variations in funding over time around the average.

(g) In order to make funding decisions that affect an overall infrastructure, it may be desirable to bring together many decision makers and stakeholders in meetings where these decisions can be proposed and finalized. Inevitably, “what if” questions come up regarding possible changes to the proposed funding levels. It is often preferable to get a good (perhaps not even necessarily exact) answers to such questions on the spot, rather than having to reconvene the meetings days or even weeks later with answers to the initial questions.

(h) Often, decision makers and/or stakeholders view the condition of the infrastructure articles differently than do the people that are directly involved in them. For this reason, it can be important that presentations of funding allocation analyses be in terms that the participants in the decision making process understand; mapping if necessary the underlying technical measures to the high-level indicators of infrastructure condition.

(i) By their very nature, infrastructure transformational activities have impacts on the infrastructure article conditions that can vary in terms of duration. For example, repaving a road can result in an improved condition that can last many years or even decades, while replacing the oil of an engine may result in an improved condition of only several months or weeks. Hence, it can be necessary to model a range of types of infrastructure classes.

(j) It can be considered fundamental to global optimization to know the incremental benefit/cost ratio of each class of infrastructure articles. For instance, when the incremental benefit/cost ratio of one class is lower than it is for another, an overall improvement in optimization may result if funding is moved from the former to the latter.

(k) Furthermore, it can be critical to know the incremental benefit/cost ratio of each subclass of infrastructure article within a class, as again it could be an overall improvement in optimization to move funding from a subclass with a lower ratio to a subclass with a higher ratio.

(l) Optimizing the overall condition of an infrastructure by applying the available funding with the proper tool and approach to make improvements to the best set of infrastructure articles can be a major step towards a sound and comprehensive case for additional funding, as it may show that the additional funding will be used where it will have the highest positive impact on the overall asset condition. The approach and tool, though, may be desired to be able to document the optimal case, as well as show the improvements that would obtained with the additional funding.

(m) When decisions are made to reach a certain goal of condition within a particular class or subclass of infrastructure articles, then it is important to know the amount of funding needed to achieve that goal, and to determine (and to minimize) the negative impacts on the condition other classes/subclasses of their reduced funding.

(n) In short, the approach and tools used may be desired to provide a sound basis for the funding decisions that will optimize the overall condition of the infrastructure by identifying where funding adjustments should be made, and by clearly indicating when an optimal distribution has been selected, which in turn may direct the funding to those transformation activities that will contribute the most to the overall infrastructure condition.

These shortcomings in the approaches and tools currently available to decision makers result in less-than-optimal allocation of funding for infrastructure improvement projects, which in turn results in annual losses that may well exceed hundreds of billions of dollars in the U.S. and trillions of dollars globally due to inadequate optimization in the public and private sector infrastructure expenditures for transportation, manufacturing, defense, energy production, communications and other infrastructure-intensive sectors. Thus, an incremental improvement in the investment analysis of these types of infrastructure assets could result in tremendous savings to taxpayers and/or shareholders.

In an effort to improve the practice of infrastructure investment analysis and more specifically to maximize the benefit/cost ratio of an infrastructure asset portfolio a need exists for a system that overcomes the above-stated disadvantages.

### SUMMARY OF THE INVENTION

The present invention provides a variety of aspects, which may be combined in different ways to present embodiments of an easy-to-use, straightforward method and apparatus for performing interactive optimization analysis on different classes and subclasses of infrastructure articles by allowing a user to modify different parameters (such as inflation, budget allocations, etc.) that affect the amount of funding available to perform improvement activities on each of a plurality of classes of infrastructure articles, and to determine the expected results, in order to prioritize the said transformation activities so as to optimize the impacts of the improvement transformation activities on the global set of infrastructure articles.

### BRIEF DESCRIPTION OF THE DRAWINGS

NOTE: The reference numbers for these figures are listed starting on page 13.

FIG. 1 illustrates an overview of three levels of activity that may contribute to the optimized improvements of the infrastructure, made in accordance with one embodiment of the present invention.

FIG. 2 illustrates one embodiment of a multi-step process of performing funding trade-off analysis and predicting ultimate performance of the improvement activities to optimize the global improvement to the overall infrastructure, as performed in accordance with one embodiment of the present invention.

FIG. 3 illustrates a benefit/cost profile for a specific class of infrastructure articles, a specified funding level (i.e. “budget limit”), and the resulting collection of improvement activities proposed for that class by the class-level planning analysis for that class of infrastructure articles.

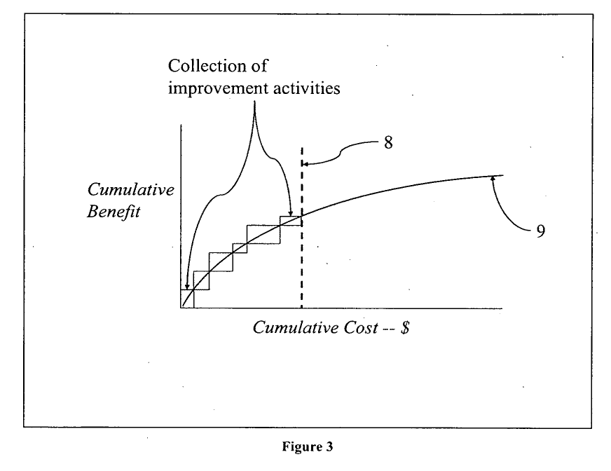

FIG. 4 illustrates how, for a specific class of infrastructure articles, a change in the level of funding applied can impact the number (and possibly the scope) of infrastructure articles proposed by the class-level planning analysis for that class of infrastructure articles, and furthermore, result in a change in the marginal incremental benefit/cost slope for that class.

FIG. 5 illustrates one example of a data input table that could be output from a class-level planning analysis for a particular class (in this case, pavement), and for a particular funding level (such as high, nominal, or low), made in accordance with one embodiment of the present invention.

FIG. 6 illustrates how class-level planning analysis may result for each asset class roll up into trade-off analysis, made in accordance with one embodiment of the present invention.

FIG. 7 illustrates some various types or levels of “What-if?” analysis that can be performed at the overall infrastructure level, made in accordance with one embodiment of the present invention.

FIG. 8 illustrates the concept of shifting funds from one class of infrastructure articles (in this case, Class A) to, another class (in this case, Class B), affecting the funding level over time of both classes of infrastructure articles, made in accordance with the present invention.

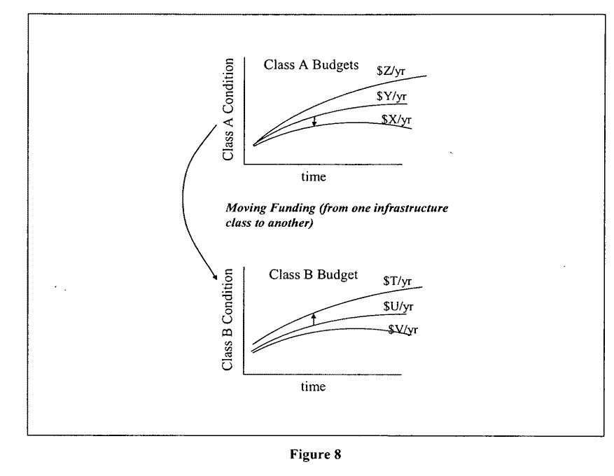

FIG. 9 illustrates a concept of the incremental change in condition associated with an incremental change in funding for two different classes of infrastructure articles (in this case, Class A and Class B), showing how moving funding from one class to another can result in a larger improvement of condition in the receiving class (Class B) than decline in the condition of the giving class (Class A), a “favorable compromise”, perhaps resulting in a global improvement of the infrastructure condition, made in accordance with one embodiment of the present invention.

FIG. 10 illustrates how one embodiment of the subject invention may use a non-linear curve fit to better model the benefit/cost curve associated with each class (or subclass) of infrastructure articles than a linear fit, in accordance with the present invention.

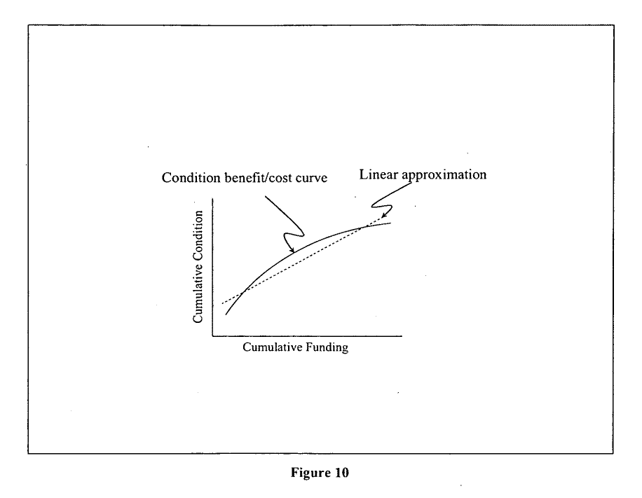

FIG. 11 illustrates conceptually how one embodiment of the invention may accomplish the objective of modeling a relationship between funding and condition for each class or subclass of infrastructure articles using the input data tables, developing a logical table representing the funding and associated conditions for each infrastructure class and subclass, as modified by the changes to the funding parameters made by the user, in accordance with one embodiment of the present invention.

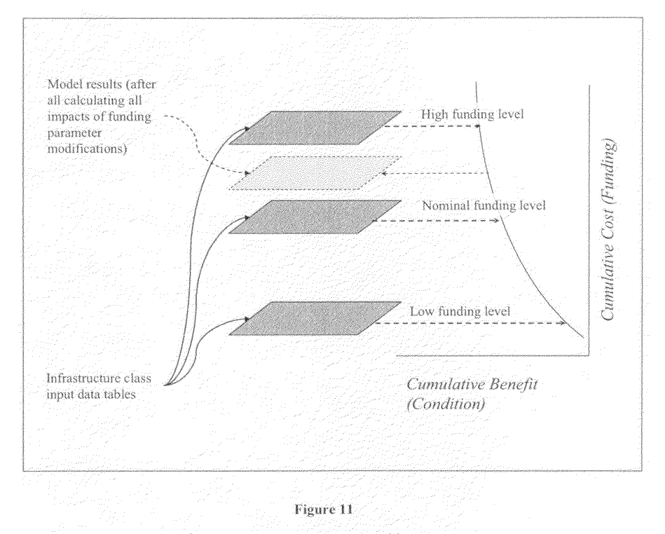

FIG. 12 illustrates a part of an embodiment of a user interface for one embodiment of the invention, representing the screen where a user can make changes in the funding parameters by moving funds from one infrastructure class to another, and observe the changes to the key indicators, made in accordance with one embodiment of the present invention.

FIG. 13 illustrates a part of an embodiment of a user interface, representing the screen where overall fiscal constraint parameters can be changed by the user, and showing the impacts of those changes on the relative funding levels for each class of infrastructure article, made in accordance with one embodiment of the present invention.

FIG. 14 illustrates a part of an embodiment of a user interface, representing the screen where a user can make changes in the funding parameters by moving funds from one infrastructure subclass (e.g. Interstate highways) to another (e.g. secondary or non-NHS highways), and observe the changes to the key condition indicators, made in accordance with one embodiment of the present invention.

FIG. 15 illustrates a part of an embodiment of a user interface, representing the screen where a user can observe the effects of changing funding parameters on various views of the subclasses of infrastructure articles associated with a second subclass category (in this case, the subclass is “MyDistrict2” of the subclass category “geographic districts”), made in accordance with one embodiment of the present invention.

FIG. 16 illustrates a class/subclass of infrastructure articles for which the condition is durable, made in accordance with one embodiment of the present invention.

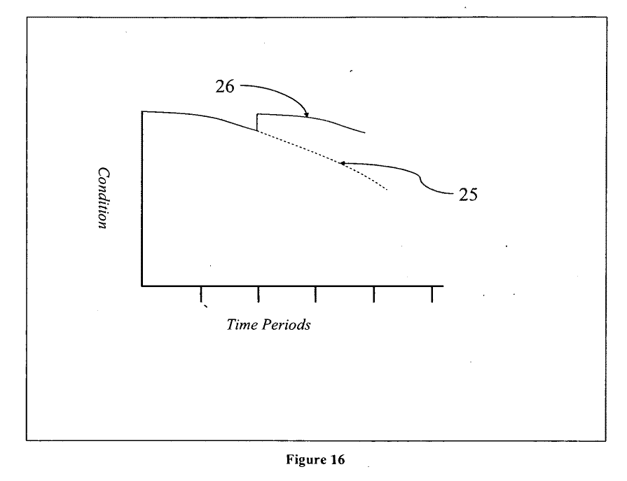

FIG. 17 illustrates a class/subclass of infrastructure articles for which the condition is ephemeral (or fleeting”), made in accordance with one embodiment of the present invention.

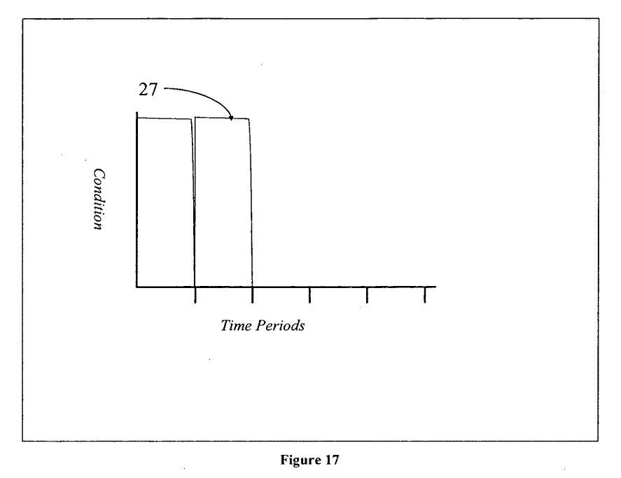

FIG. 18 illustrates the core apparatus, made in accordance with one embodiment of the present invention.

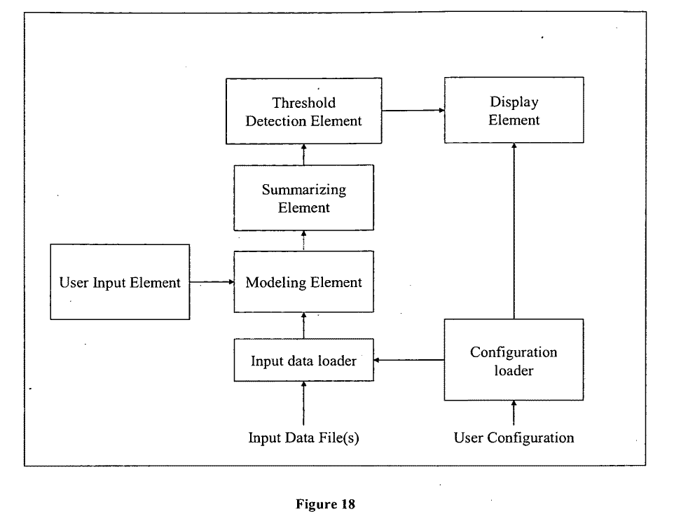

### DETAILED DESCRIPTION OF PREFERRED EMBODIMENTS

As mentioned earlier, the present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, methods, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

An initial embodiment may be considered as presenting a baseline use of the invention that performs funding tradeoffs between classes and subclasses of infrastructure articles in an overall context of optimizing the use of that funding in performing improvement activities to the infrastructure, resulting in the optimum improvement of infrastructure condition for the overall available funding.

The invention may create an analytical framework (both method and apparatus) that brings together disparate analysis results for different classes of infrastructure articles in a manner that allows the user to explore the implications, over a specified time horizon, of various changes to the fiscal constraint and funding parameters that may affect the funding levels used to perform improvement and transformation activities to the various classes (and subclasses) of infrastructure articles.

As used in this description, common dictionary definitions should be understood as incorporated for each term. In addition and for explanation clarity, the following terms should also be understood in the following contexts and with the following meanings:

| Term | Context |
|---|---|
| Class of | May include a set of similar infrastructure articles for which |
| infrastructure | transformation activities, along with the associated funding, |
| articles | may need to be prioritized in order to optimize the resulting |
| | improvements to those articles. The final specification of |
| | which infrastructure articles are included within a specific |
| | class can have as much to do with the organization as with the |
| | physical nature of the articles. (A sample list of types of |
| | infrastructure classes, which does not intend to be complete, |
| | is found on page 20). |
| Infrastructure | May include specific asset items, such as a segment of |
| articles | roadway, particular bridge, sewer line, pipe segment, vehicle, |
| | etc. that make up an infrastructure class or subclass. |
| Subclass | May include a way of sub-dividing the totality of |
| Category | infrastructure articles within an infrastructure class. Different |
| | infrastructure classes may have different subclass categories; |
| | e.g. functional classification for roadway infrastructures, and |
| | vehicle type for fleet infrastructures. |
| | Different orthogonal subclasses (e.g. geographical, |
| | organizational, jurisdictional, etc.) can also be defined. |
| Subclass | May include a specific selection of one of an asset type within |
| | a subclass category. For example, “Interstate highways” |
| | could be a specific subclass of the infrastructure class of |
| | roadways; “Heavy Vehicles” could be a subclass under the |
| | infrastructure class of fleets, etc. |
| Weight | May include a value representing the relative size or |
| (“Applied-to”) | dimension or importance of an infrastructure article or |
| | collection of articles relative to others |
| Infrastructure | May include a project that results in a physical change to an |
| transformation | underlying infrastructure article to improve its condition; |
| activity | specific examples may include laying down pavement on a |
| | roadway segement, reconstructing a bridge, upgrading the |
| | HVAC of or re-roofing a building, upgrading a fleet of |
| | vehicles, etc. |
| Condition | May include a value representing the physical condition (e.g. |
| | state, health, performance, etc.) of an infrastructure article. |
| | For computational purposes, the condition may be |
| | manipulated as a numerical value, but may also be input and |
| | displayed on any scale that can be mapped to a numerical |
| | value (for example, a letter grade A-F such as used to grade |
| | school work). Condition can also refer to the weighted |
| | average condition of any set of infrastructure articles; for |
| | example a subclass or the whole class. NOTE: The input and |
| | output mapping scales need not be the same. |
| Benefit | The benefit may be equivalent to an improvement in condition. |
| Funding | May be used in a variety of ways, including but not limited to: |
| | (a) In the input data, the funding may be the |
| | amount of money recommended by the infrastructure class |
| | level planning analysis to spend on infrastructure article |
| | improvement activities |
| | (b) The amount of money to be invested in a class |
| | (or subclass) of infrastructure articles —including adjustments |
| | made as part of the optimization analysis; perhaps used to |
| | then model the expected resulting improvements in condition |
| | (i.e. benefits). |
| Improvement | Essentially may include projects to work on one or more |
| activities | individual infrastructure articles, and perhaps which may |
| | result in improvements to the condition of the associated |
| | infrastructure articles. |
| Deterioration | May include the effect whereby the condition of an |
| | infrastructure article degrades over time. This degradation can |
| | occur quickly (corresponding to a more ephemeral condition) |
| | or slowly (corresponding to a more durable condition), |
| | depending on the nature of the infrastructure article. |
| Durability factor | May include a degree to which improvements in condition |
| | associated with infrastructure article improvement activities — |
| | along with the inherent deterioration (if applicable) of the |
| | condition for those infrastructure articles —will carry over |
| | from year-to-year. |
| Input data table | May include a table of data representing the outputs of an |
| | infrastructure class level planning analysis |
| | (a) may represent one or more time periods of |
| | work to be done on one or more infrastructure articles within |
| | the class and within any defined subclass categories of |
| | infrastructure articles. |
| | (b) may provide the recommended funding for |
| | improvement activities, together with the weight |
| | (quantification) of the infrastructure articles covered by that |
| | row and the resulting condition of the infrastructure articles |
| | covered by that row. |
| Input data table | May include a collection of three or perhaps even more input |
| set | data tables for a specific class of infrastructure articles, each |
| | of which may correspond to a different overall level of |
| | funding for that class of infrastructure articles. For some |
| | embodiments, there may be a minimum of three tables used to |
| | represent high, nominal, and low funding levels. |
| Time period | May include the increment of time within in an analysis |
| | which is to be done. Typically a year, but could also be a |
| | quarter, month, or any other time period. |
| Time horizon | May include the ensemble of time periods for which the |
| | analysis is to be done. For some embodiments, many of the |
| | examples may be based on a time horizon of 10 years, but could |
| | be any duration. |
| Class level | May include the analysis (approach, and potentially one or |
| planning | more tools) to determine the recommended set of projects to |
| subsystem | perform, based on the analysis of a single class of |
| | infrastructure articles. E.g. “pavement module” or “bridge optimizer”. |
| Class level | May include the output of a class-level planning subsystem, |
| planning analysis | such as the data input tables that summarize the |
| results | transformation activities proposed for each particular |
| | infrastructure class, along with the associated funding. |

To further set a background from which to understand some embodiments of aspects of the invention, an initial context for some elements depicted by reference numerals in the figures are listed. Although not limiting, these may perhaps include initial aspects that may include, but not be limited to aspects perhaps as follows:

1. may indicate aspects including a step at which the optimization choices are implemented, and transformation work is performed; an optimized set of improvements are made to the physical infrastructure.

2. may indicate aspects including a step in which the funding optimization choices are made, reviewed, and finalized and communicated.

3. may indicate aspects including a step in which each class-level planning analysis is performed, perhaps resulting in a set of recommended infrastructure article improvement activities for that class (and subclasses within that class).

4. may indicate aspects including a step in which actual improvements are made to the infrastructure using the invention to determine the optimal set of improvement activities to perform.

5. may, indicate aspects including steps in which the invention is used to process and display the impacts of the changes to funding parameters, assisting the user in finding the optimum funding choices, given the fiscal constraints.

6. may indicate aspects including steps in which the data used by the invention to model the underlying infrastructure articles is produced.

7. may indicate aspects including a specific funding level and associated resulting condition for a class or subclass of infrastructure articles, from class-level analysis.

8. may indicate aspects including a particular funding level on the benefit/cost curve for a class or subclass of infrastructure articles.

9. may indicate aspects including a curve modeling the benefit-to-cost ratios of the collection of infrastructure improvement activities.

10. may indicate aspects including a derivative of the benefit/cost curve for a class or subclass of infrastructure articles at a given point, which represents the incremental improvement to the condition associated with an incremental change to the funding level.

11. Not assigned

12. may indicate aspects including the incremental improvement to the condition associated with an incremental change to the funding level for Class A of infrastructure articles.

13. may indicate aspects including the incremental improvement to the condition associated with an incremental change to the funding level for Class B of infrastructure articles.

14. may indicate aspects including the condition graph for an example class of infrastructure articles (in this case, segments of roadway) over time (in this case, over ten years) for one or more funding profiles.

15. may indicate aspects including the scale of a condition (in this case, expressed % good-to-excellent) for an example class of infrastructure articles.

16. may indicate aspects including the scale of another condition (in this case, expressed as a letter grade) for another example class of infrastructure articles.

17. may indicate aspects including a representation of a benefit/cost curve for an example class of infrastructure articles.

18. may indicate aspects including a representative indication of position on the benefit/cost curve of the current funding level for an infrastructure class.

19. may indicate aspects including a representative of the derivative (dy/dx) of the benefit/cost curve equation at the current funding level for an infrastructure class.

20. may indicate aspects including examples of three different subclasses of infrastructure articles (in this case, of the subclass category “functional classification”).

21. may indicate aspects including an example representation of the condition time graph, perhaps where the condition of all subclasses (Interstate, Other NHS, and Non-NHS) of one subclass category (functional classification) are rolled up for all subclasses for a specific subclass (MyDistrict 2) of another subclass category (geographical districts) for each time period.

22. may indicate aspects including an example representation of the condition bar charts; where the condition of each subclass (Interstate, Other NHS, and Non-NHS) is rolled up over all time periods for a specific subclass (MyDistrict 2) of another subclass category (geographical districts).

23. may indicate aspects including a slider control perhaps even manipulated to the left or right by the user to move a corresponding amount of funding between the infrastructure classes on the left and on the right below the slider.

24. may indicate aspects including a “thermometer” graph, showing the infrastructure class on the right (in this case), the high, low, and current (i.e. as a result of the changes to the fiscal constraint and funding parameters made up to that point) level of funding.

25. may indicate aspects including a sample curve showing how the condition (of the infrastructure class, subclass, or article) would deteriorate over time without the benefit of an improvement activity.

26. may indicate aspects including a sample curve showing how a durable condition (of the same infrastructure class, subclass, or article) would deteriorate over time with the benefit of an improvement activity performed in the second time period.

27. may indicate aspects including a sample curve of an ephemeral (or fleeting) condition; one that essentially lasts only for the specific period in which work is done, and then drops to zero at the end of the period.

28. may indicate aspects including a detailed planning step where the results of funding allocation decisions are finalized into the organization's project plan.

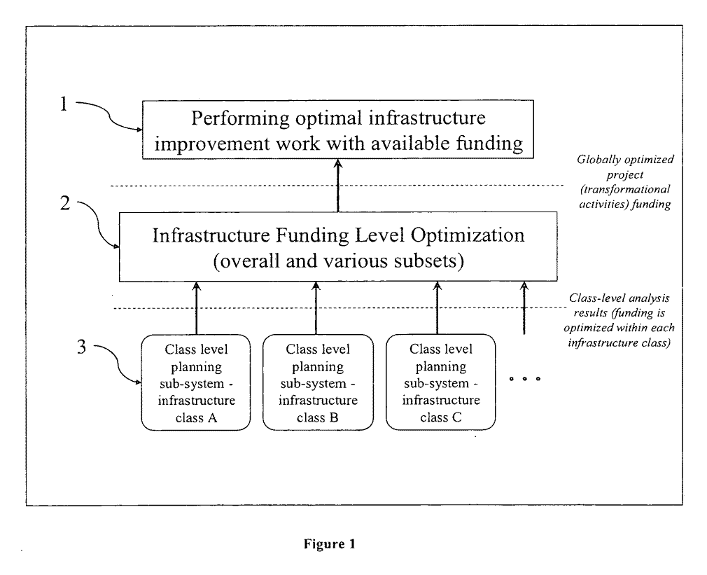

With the foregoing, it can be understood that FIG. 1 illustrates an embodiment of the main levels that may make up an analytic framework. Data tables from 3 may be input to 2 which may use the input data to model the multiple classes of infrastructure articles in the entire infrastructure, enabling the user to identify the optimum funding decisions that are then implemented in 1, resulting in optimal improvements to the infrastructure given the fiscal constraints.

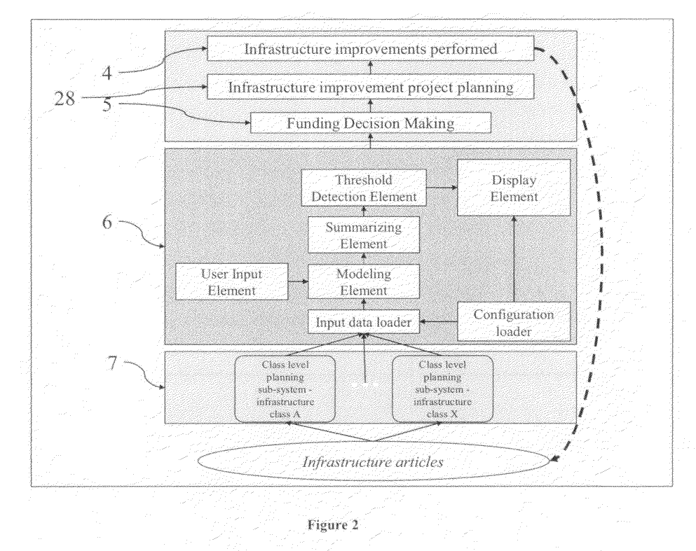

FIG. 2 illustrates some steps involved that may be used in optimizing improvements to the condition of the overall infrastructure. In 6, each of various classes may be modeled in such a way that a recommended set of infrastructure article improvement activities are identified, for each time period over the time horizon, for that class of infrastructure articles for one or more given funding levels. That data may then be used with the invention in 6 to perform the analysis that might ultimately result in the optimization across classes of infrastructure articles. Within 6, the following steps may be performed:

(a) The input data from each class level planning analysis may be loaded

(b) A model may be created for each class and subclass of infrastructure articles, which contains the relationship between infrastructure article funding and the resulting condition.

(c) The user may modify various funding parameters through the controls

(d) The user can then observe how the choices in the funding parameters affect the condition of each of the classes of infrastructure articles.

The resulting selection of funding choices may then be confirmed (e.g. with all stakeholders) in 5, then incorporated into the organization's project planning, and then finally the improvement activities are performed in 4, where the infrastructure articles are improved. This in turn feeds back into 7 for a future iteration.

Hence, the present invention provides an analytic framework that results in users within an organization being able to more effectively select the funding choices that in turn result in the best (most optimized) funding for improvement activities and the resulting improvement on the infrastructure articles.

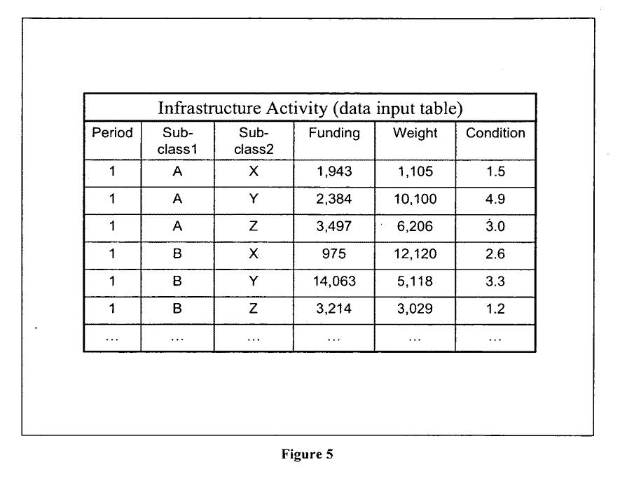

FIG. 5 shows an example input data table with the various data fields that could be used (some of which are optional). For each class of infrastructure articles, at least three logical data input tables (which may be combined into one physical table for ease of use) may be used, representing the High, Nominal, and Low funding levels per time period.

The input data tables may contain multiple rows, each of which may cover the level of funding to be applied to a specific subset of infrastructure articles (e.g. those that belong to each intersection between specified subclasses) during a given period, and the resulting condition of those infrastructure articles after the recommended improvement activities are performed. Specifically, each row in the input data tables may possibly include the following fields:

(a) Time period—the period (e.g. year) in which work is to be performed;

(b) Subclass 1 (optional)—if used, this may represent to which subclass within a first subclass category the infrastructure articles covered by this row belong;

(c) Subclass 2 (optional)—if used, this may represent to which subclass within a second subclass category the infrastructure articles covered by this row belong;

(d) Funding—the amount of money that would be spent on performing the improvements for the infrastructure articles covered in this row in the associated time period;

(e) Weight—A numerical value perhaps representing the relative size or dimension or importance of the infrastructure articles to which the data in the row applies;

(f) Condition—the resulting condition for the infrastructure articles to which the data in the row applies, once the improvement projects that use the funding are performed, and after any deterioration of the condition from the previous time period occurs.

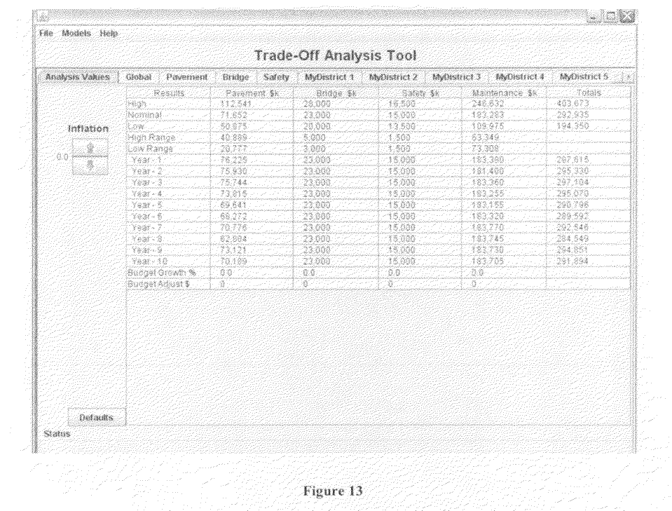

FIG. 13 illustrates how some of the fiscal constraints affecting the funding optimization analysis can be entered and the results observed.

(a) The inflation rate used in the model can be adjusted by the user to match an anticipated or simply a possible (“what if”) rate for the purposes of the analysis.

(b) The user can input changes in funding that would be applied to each class of infrastructure articles (expressed either as a rate of change, or as an added or subtracted amount per time period)

(c) The resulting impacts on the funding for each class of infrastructure articles for each time period is summarized in the table.

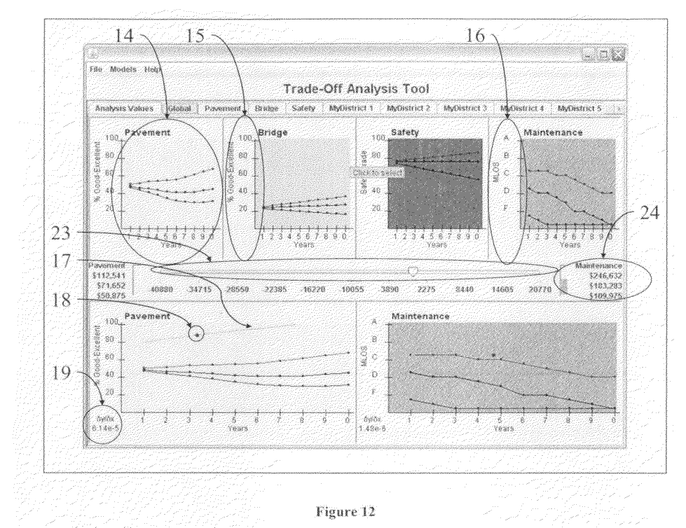

FIG. 12 illustrates how further modification of the funding parameters can be performed by the user by moving funding between classes of infrastructure articles, and the resulting impacts on the conditions of each class of infrastructure articles can be observed:

(a) 14 in FIG. 12 shows the graph of the condition for a sample class of infrastructure articles over time. The middle line shows the expected evolution of the condition for that class based on the level of funding, which results from the funding modifications that have been entered by the user;

(b) 23 in FIG. 12 shows the control (slider) that allows a user to modify the funding levels of two classes by moving an amount from one class to another.

(c) 17 in FIG. 12 shows a representation of the benefit/cost curve for the selected class of infrastructure articles (in this case, pavement).

(d) the dot 18 in FIG. 12 shows where on the curve the current funding level (incorporating all modifications made by the user) is located

(e) The derivative (incremental benefit/incremental cost) 19 is displayed as well.

(f) 24 in FIG. 12 shows ‘thermometer’ type of display that indicates the current funding level for the selected class of infrastructure articles (in this case, Maintenance) relative to the high and low funding levels that have been entered for that class.

In this way, the user can perform tradeoff analyses by systematically varying fiscal or other resources between asset classes and making comparisons of how the corresponding asset condition measures change for each asset class.

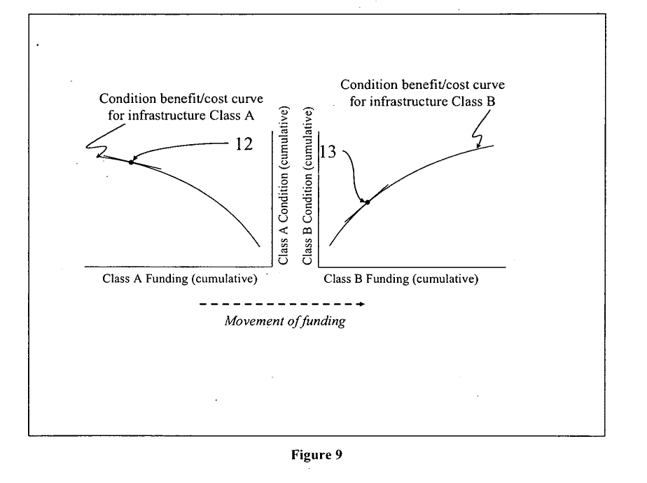

In addition, the user can identify the incremental change in benefit/cost for each infrastructure class as the allocation of funding to one or more asset classes vary, enabling the user to understand when small shifts in funding allocation between infrastructure classes may have a major impact on one class (e.g. Class A) and a much smaller impact on another class (e.g. Class B) as shown in FIG. 9.

Use of the present invention for different infrastructure-centric public or private sectors may be enabled by utilizing different asset class analysis results as inputs to the funding analysis and optimization apparatus and associated process.

A partial list of the types of infrastructure-centric organizations that manage multiple classes of infrastructure articles and that could benefit from the present invention is given below:

(a) Public transportation departments;

(b) Airport authorities;

(c) Government agencies responsible for managing networks of public assets such as parks and bases;

(d) Educational institutions managing large spaces and buildings;

(e) Irrigation districts;

(f) Water and sewer authorities;

(g) Telecommunications companies;

(h) Pipeline companies;

(i) Railroads;

(j) Manufacturing companies.

The above list is meant to give an idea of the types of organizations that could use the present invention, and is not meant to be a comprehensive list.

Some of the major advantages of the present invention are its ability to help policy makers better understand the trade-offs of their investment policy decisions to ensure that billions of dollars invested in infrastructure asset management result in the highest return on investment as the improvement activities are performed on the infrastructure articles using the optimized funding choices made using the invention.

In one embodiment of operation, the steps involved from beginning to end may involve the following sequence:

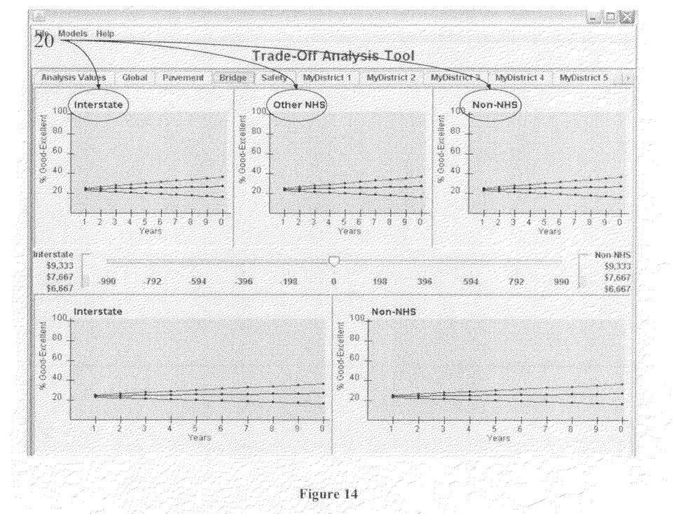

(a) Initially, the funding analysis and optimization apparatus may be set up to represent the actual infrastructure classes and subclasses that are appropriate for the organization. This may involve selecting the class names and colors (14 in FIG. 12), identifying the subclass names (20 in FIG. 14), specifying the appropriate condition measure scales to use (e.g. 15 or 16 in FIG. 12), adapting to the specific input data table format that will be produced by the class-level planning subsystema (e.g. any variances to the format shown in FIG. 5), selecting the mapping between the condition as reported in the input data table and as expected in the output chart scales.

(b) The various organizational entities may perform infrastructure class-level analysis for each infrastructure class to be included in the optimization. This may be done using the class-level planning subsystems that are generally used to manage individual infrastructure classes. The results of these analyses may then be formatted as per FIG. 5, which is generally a matter of simple output report formatting from typical class-level planning subsystems.

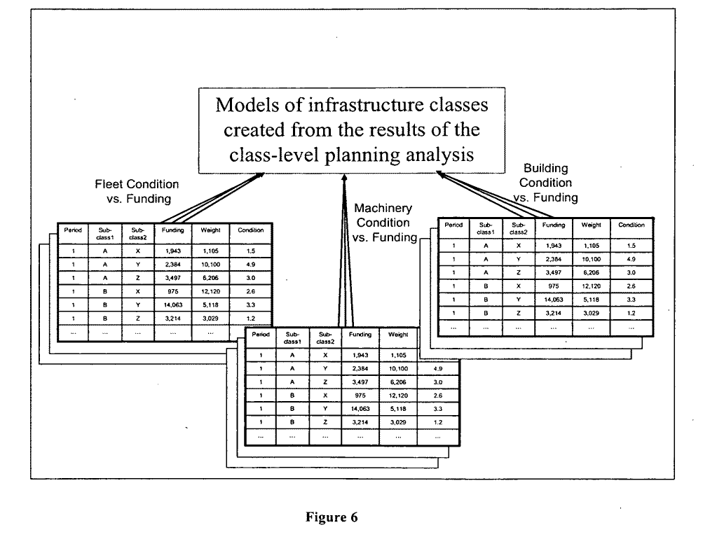

(c) The output results from those analyses may be loaded into the funding analysis and optimization apparatus (lines from 7 leading to 6 in FIG. 2) to create a set of models for the different classes of infrastructure articles (FIG. 6).

(d) The user may then enter the fiscal constraints—such as e.g. inflation, reduced funding available to a particular infrastructure class, etc.—into the funding analysis and optimization apparatus (as per FIG. 13).

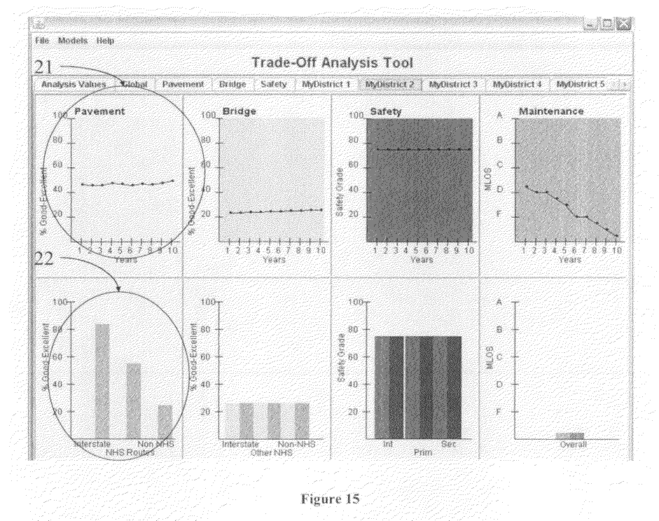

(e) The user may then use the controls (perhaps sliders, as included in 23 in FIG. 12 and FIG. 14) to effect changes to the funding distribution across classes or subclasses; i.e. perform a tradeoff analysis. The user may monitor the indicators (14, 17, 18, 19 and 24 in FIG. 12; 21 and 22 in FIG. 15) to determine when the best favorable compromises have been achieved given the fiscal constraints.

(f) The communication of the results to the stakeholders can be done by presenting the funding analysis and optimization apparatus results to them in the meeting room, allowing all parties present to see the modifications performed and the results achieved, as well as giving them the opportunity to ask “what-if . . . ?” questions that can also be investigated with the help of the funding analysis and optimization apparatus.

(g) Alternatively, the results can be documented and distributed for off-line discussions and agreement.

(h) Once agreement from the relevant stakeholders as to the funding allocation is obtained, the results may be provided to the detailed planning step for infrastructure improvements (28 in FIG. 2), where the project finalization takes place (including preparation for bidding, etc. as appropriate).

(i) Finally, the optimal set of infrastructure improvement activities are performed (4 in FIG. 2), using the selected funding allocation, resulting in the best possible improvements to the underlying infrastructure with the amount of funding available.

Approaches according to embodiments of the invention may use the method and apparatus of this invention to overcome the shortcomings listed for the current state of asset management. The specific advantages are listed throughout this description. It may be important to highlight that this approach can result in a globally optimized use of available funding to improve the underlying infrastructure, which may result in significant savings—in the billions of dollars—for infrastructure-intensive private and public entities.

Another embodiment is an extension of the prior embodiment, and may enable the user to perform scenario analyses regarding plausible futures. For instance, the user may wish to consider various rates of inflation, or the levels of funding (annual revenue for infrastructure projects) that exceeds currently expected levels.

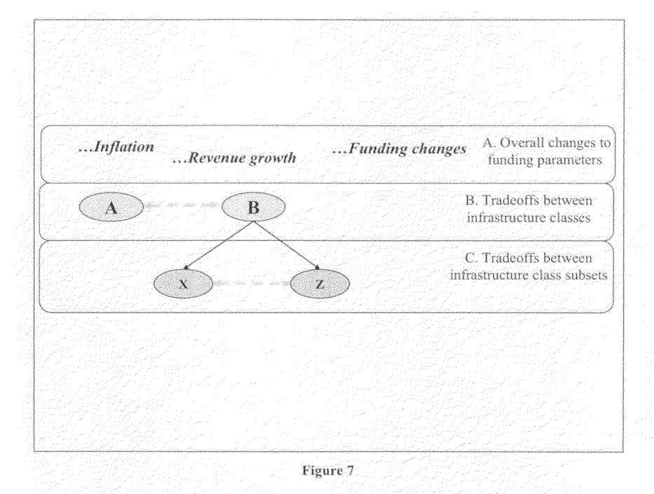

FIG. 7 shows an overview of this process. This illustrates how the user can pose various financial scenarios and perform “what-if” analyses. By varying the financial parameters such as inflation, annual revenue, or revenue growth rate, the user can consider various combinations of these parameters, where each combination comprises a “scenario”.

FIG. 13 shows an embodiment including a financial window, where the user can adjust the parameters mentioned above. Each desired combination of the financial parameter settings can be input into the analysis in this window, and then the results can be further explored regarding the impacts on the condition of the infrastructure assets.

FIG. 12 illustrates perhaps where the user could first examine the effects of considering various financial scenarios. Depending upon the financial scenario, the infrastructure asset condition values over the time horizon may be constant, increasing or decreasing. If the user wishes to “balance” the condition projections across infrastructure classes, for example, then the invention will allow the user to do so; first by choosing two classes of infrastructure to move funding between, and examine the condition results.

Then, the user may further consider each infrastructure class, by looking at the effects of the financial scenarios, as well as the class balancing, on the infrastructure subclasses. For instance, as shown in FIG. 14, the user may move funding between infrastructure subclasses within a given subclass category with the techniques shown in the window. In this way, this particular subclass can also be “balanced” in a manner similar to the balancing at the infrastructure class level.

Finally, the user can explore the effects of each financial scenario on all the subclasses of a 2nd subclass category, as shown in FIG. 15. By examining these final results, the user can determine the impacts of each financial scenario across all subclasses. Thus, the user can determine strategies and contingencies according to the likelihood of each scenario, and the risk preference of the ultimate stakeholders.

Another embodiment is a variation of the prior two whereby the user can formulate infrastructure management policies, set targets for the long-term condition of infrastructure assets, and determine the funding levels necessary to reach and/or maintain these targets and policies.

The overall approach of this type of a system is shown in FIG. 7. This approach may involve either making tradeoff decisions for various infrastructure improvement funding levels, or making changes to the financial inputs to the analysis. By setting infrastructure condition targets and long-term policies, the user can explore these degrees of freedom in determining how to best meet all targets with available resources.

The user can start at either the infrastructure class level or the subclass category level for setting condition targets. It may be recommended that the user start at the class level, shown in FIG. 12. This can begin by specifying a target condition for an infrastructure class and determining the level of funding that would be needed to reach that level of condition. By “balancing” funding among infrastructure classes, the user can determine whether the targets are attainable with the “nominal” amount of funding available (the total of the nominal funding amounts for all infrastructure classes). If not, more funding may need to be added to the analysis.

In this case, the user can add annual revenue to any of the infrastructure classes, as shown in FIG. 13. The choices here are to either increase the annual revenue growth rate or to add an additional amount of annual revenue (constant) to any given infrastructure class.

Then the user can return to balancing funding across infrastructure classes, to determine whether the targets are now being met, as shown in FIG. 12. The user can also explore the subclass levels, as shown in FIG. 14 and FIG. 15, to adjust those condition levels, per the condition targets that may apply at the subclass level.

Other embodiments may be created from the principles disclosed herein. These may include:

1) Allowing trade-off between subclasses of multiple subclass categories,

2) Having a second subclass category that is not common to all infrastructure classes, among other possibilities.

3) Having multiple (more than two) subclass categories,

From the description above, a number of advantages of some embodiments of our invention become evident. These may include, but not be limited to:

(a) Finding optimal selection of funding levels, ensuring best use of funds to physically improve the infrastructure (apply pavement, fix bridges, deploy safety devices, perform maintenance, etc.)

(b) Handling complex math calculations that cannot be done manually

(c) Transforming data to provide information in a form that is easily understood by decision makers and stakeholders

(d) Providing analysis perhaps resulting real-time for interactive analysis, rather than requiring repeated iterations going back to the class-level planning systems, as their time cycles can be several days to a few weeks, and get in the way of effective decision-making meetings.

(e) Performing non-linear math in order to more accurately model the interactions between funding and the anticipated improvements in condition, and also to enable the features described in point (f) below, which rely on a non-linear model in order to be useful.

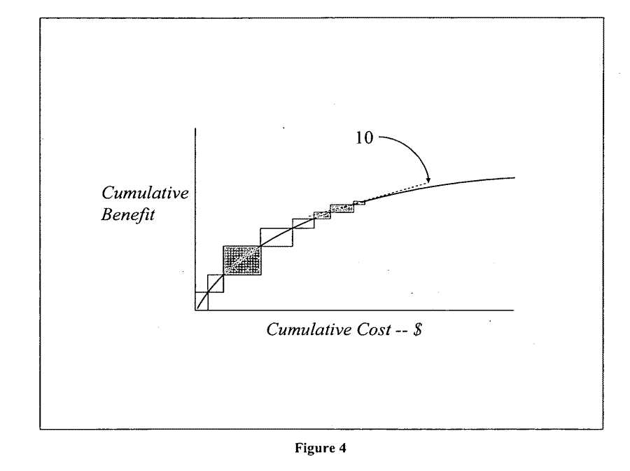

(f) Performing incremental benefit/cost calculations (10 in FIG. 4 and 12 and 13 in FIG. 9) that provide the related user indicators (see 18 and 19 in FIG. 12) as a significant value addition. A component of asset expenditure or investment decision making may be to be able to compare return-on-investment (ROI) from among alternative funding allocations between classes and subclasses and look for favorable compromises. Here, the non-linear math of feature (e) above is combined with a meaningful portrayal of the information (the various display panels in FIG. 12) for maximum insight into investment decision making. The overall data format with which the invention operates supports the non-linear modeling of the condition of the infrastructure articles versus the funding levels applied, and both are essential to creating the incremental benefit/cost comparison between classes of infrastructure articles; or in other words trading off funding between these infrastructure classes and finding favorable compromises.

(g) Providing the ability to choose any two infrastructure classes, and trade them off—This feature may enable the user to consider investments head-to-head, which is similar to the premise of doing pair-wise comparisons. In other words, when a decision maker has only two alternatives to consider, they can clearly compare them. This capability, combined with point (f) above may enable the user to have ultimate capability in making vivid comparisons between funding alternatives, and thus the ability to make tough choices.

(h) Enabling adaptability and/or flexibility of the product—The funding analysis and optimization apparatus can easily be adapted to the infrastructure analysis framework for a wide variety of infrastructure article classes, subclasses, and condition measures. For Departments of Transportation, for example, the infrastructure classes might be Bridge, Pavement, Safety, Maintenance, Capacity, and other programs/objectives that require funding, and that provide measureable condition benefits. For Manufacturing the classes of infrastructure articles could be Fleet, plant equipment, Facilities/Buildings, and other classes. For County Public Works—Roads and Bridges, Drainage/Sewers, Sanitary Water, Fleet, Buildings, and Parks, etc. are relevant. The second-level of funding tradeoff decision making is totally flexible as well. The definition of subclasses can either be the same across infrastructure classes, or can be unique per each infrastructure class.

(i) Handling ephemeral and/or durable condition considerations—This is perhaps the most subtle of the enabling features of the funding analysis and optimization apparatus. Because of the design of the funding analysis and optimization apparatus, the user can model either or both types of infrastructure articles.

(j) Providing the ability to pose and consider “blocky funding” over the time horizon (i.e. significantly different funding per time period, for specific time periods, as chosen by the user).

Although the above embodiments contains many specificities, these should not be construed as limiting the scope of the embodiments, but merely as providing illustrations of some of the presently preferred embodiments. These descriptions should not be construed as limitations in the scope of any embodiment, but as exemplifications of the presently preferred embodiments thereof. Thus, the scope of the invention should be determined by the appended claims and their legal equivalents, and not by the examples given.

As can be easily understood from the foregoing, the basic concepts of the present invention may be embodied in a variety of ways. It involves both infrastructure management techniques as well as devices to accomplish the appropriate infrastructure transformation. In this application, the management devices are disclosed as configurations through which the results described may be achieved. They are simply the natural result of utilizing the computational devices as intended and described. In addition, while some methods are disclosed, it should be understood that these may not only be accomplished by software or configured computers but also can be varied in a number of ways. Importantly, as to all of the foregoing, all of these facets should be understood to be encompassed by this disclosure.

The discussion included in this description is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that are now included or may be added to any subsequent patent application.

It should also be understood that a variety of changes may be made without departing from the essence of the invention. Such changes are also implicitly included in the description. They still fall within the scope of this invention. A broad disclosure encompassing both explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date. With this understanding, the reader should be aware that this disclosure is to be understood to support this and any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a step such as “varying” should be understood to encompass disclosure of a variation element—whether explicitly discussed or not—and, conversely, were there effectively disclosure of a “variation element”, such a disclosure should be understood to encompass disclosure of a step of “varying” and even a “means for varying” Such changes and alternative terms are to be understood to be explicitly included in the description.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the processing devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein. In addition and as to computer aspects and each aspect amenable to programming or other electronic automation, the applicant(s) should be understood to have support to claim and make a statement of invention to at least: xvi) processes performed with the aid of or on a computer as described throughout the above discussion, xv) a programmable apparatus as described throughout the above discussion, xvi) a computer readable memory encoded with data to direct a computer comprising means or elements which function as described throughout the above discussion, xvii) a computer configured as herein disclosed and described, xviii) individual or combined subroutines and programs as herein disclosed and described, xix) the related methods disclosed and described, xx) similar, equivalent, and even implicit variations of each of these systems and methods, xxi) those alternative designs which accomplish each of the functions shown as are disclosed and described, xxii) those alternative designs and methods which accomplish each of the functions shown as are implicit to accomplish that which is disclosed and described, xxiii) each feature, component, and step shown as separate and independent inventions, and xxiv) the various combinations and permutations of each of the above.

With regard to claims whether now or later presented for examination, it should be understood that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F. 3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is implied for all claims to provide support for any claim to be dependent on any other claim, such as another dependent claim, another independent claim, a previously listed claim, a subsequently listed claim, and the like. It should be understood that this is intended to also provide support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. An easy-to-use, straightforward method for performing interactive investment optimization analysis on different classes of infrastructure articles by allowing a user to modify different parameters that affect the amount of funding available to perform improvement activities on each of a plurality of classes of infrastructure articles, and determine the expected results, in order to prioritize the said transformation activities so as to maximize the positive impacts of the improvement transformation activities on the global set of infrastructure articles, comprising the steps of:
a. Inputting data table sets from each of a plurality of infrastructure class transformation activity planning subsystems, one for each class of infrastructure articles to include in the analysis;
b. Modeling the manner in which the condition of said classes of infrastructure articles are impacted by changes made to different funding parameters associated with the said classes of infrastructure articles;
c. Allowing a user to effect variations to one or more of a plurality of funding parameters;
d. Using said modeling to calculate the expected impacts of said variations in the said funding parameters on the expected condition of the infrastructure articles;
e. Summarizing the said expected results, transforming the scales to match the display scales expected by the user; and
f. Displaying the said summaries of expected impacts to the user in terms of condition of each asset class in graphical and tabular output formats permitting the user to select the most favorable set of funding parameter values;
wherein the user can use the selected set of said funding parameter values to determine the highest priorities of transformational activities to perform across all infrastructure articles, which will lead to the maximized resulting conditions of the infrastructure articles overall.

2. A method according to claim 1 further comprising the step of varying class-level and subclass-level funding parameters to cause a redistribution of funding between classes of infrastructure articles.

3. A method according to claim 1 further comprising the step of simulating changes in the economic environment in which the analysis is performed, and wherein said step of simulating changes in the economic environment in which the analysis is performed comprises the steps of:
a. changing the inflation rate parameter to model changes in the expected inflation rate, by reducing the funding available to all classes of infrastructure articles;
b. changing class-level funding growth rate parameters to model changes in the expected rate of growth in the overall funding by increasing or decreasing the funding available to each class of infrastructure articles;
c. changing the class-level funding growth rate parameters (e.g. to a negative value) to model changes in the expected inflation rate, at a different rate for each class of infrastructure articles;
d. changing the class-level funding adjustment parameters to model additions or subtractions to the funding available to a given class or subclass, on an average basis or specified by period.

4. A method according to claim 1 further comprising the step of associating a time-based condition graph with a class of said infrastructure articles and/or one or more of a plurality of subclasses thereof, and further comprising the steps of:
a. determining and setting the time interval scale on one axis;
b. determining and displaying an expected condition measure scale on the other axis; and
c. calculating and displaying a graph line showing the expected condition for each time period and over the time horizon;
wherein the user can see the expected variation of said condition over time for the said class of infrastructure articles and/or said subclasses.

5. A method according to claim 1 furthering comprising the step of associating a benefit/cost graph with a class of said infrastructure articles and/or one or more of a plurality of subclasses thereof, and further comprises the steps of:
a. calculating a graph line representing the shape of the benefit/cost curve for the said class of infrastructure articles and/or subclass thereof;
b. displaying said graph line;
c. calculating a point on that curve representing the amount of funding and resulting rolled up condition value for the said class infrastructure articles or subclass thereof;
d. displaying said point;
e. calculating a quantity that is the first derivative of the benefit/cost curve, providing an incremental benefit/incremental cost ratio, at the funding level determined by the modification of one or more of a plurality of funding parameters for the said class of infrastructure articles and/or subclass thereof;
f. determining the appropriate label indicating the units of the said number; and
g. displaying said quantity and label;
wherein the user can visualize the incremental improvement versus incremental funding level for the said class of infrastructure articles and/or said subclasses.

6. A method according to claim 1 further comprising the step of indicating to the user if/when one or more of a plurality of changes made by the user to the funding parameters result in the funding for a class of infrastructure articles and/or any subclass thereof to go above a high funding level threshold or below a low funding level threshold, wherein the results of the model become less accurate, and further comprising the steps of:
a. detecting if one of the said high funding level thresholds or low funding level thresholds have been exceeded;
b. displaying the indication that the said high or low funding level threshold has been exceeded; and
c. informing the user of class of infrastructure articles and/or subclass thereof for which the funding level threshold has been exceeded;
wherein the user can then either i) undo the most recent change of a funding parameter that caused the funding level threshold to be exceeded, or ii) make changes to other funding parameters that result in the problematic funding level to fall below the funding level threshold.

7. A method according to claim 1 further comprising the step of improving the accuracy of the model that calculates the impact of improvement projects on the condition per the funding associated with the said class of infrastructure articles, or subclass thereof over time, and further comprising the step of improving the accuracy of the model that calculates the impact of improvement projects on the condition per the funding associated with the said class of infrastructure articles, or subclass thereof over time, and comprising the steps of:
a. loading the weight associated with each row of data that is proportional to the significance of the infrastructure article that is the subject of that data row; and
b. processing the data rows such that the rollup of a plurality of data rows applies a weighted average calculation using the said weight of each row.

8. A method according to claim 1 further comprising the step of improving the accuracy of the model of the relationship between the funding applied to a class or subclass of infrastructure articles and the resulting changes in the condition of the said class or subclass, to better reflect the contribution to the condition of the said class or subclass of improvements made in prior periods, and further comprising the step of improving the accuracy of the model of the relationship between the funding applied to a class or subclass of infrastructure articles and the resulting changes in the condition of the said class or subclass, and further comprising the steps of;
a. setting a durability factor for each class or subclass of infrastructure articles;
b. summing the funding for the said class or subclass for a given time period to also add the funding for each prior time period, zero for the first period, multiplied by said durability factor in the roll-up funding calculation for the class of infrastructure articles and/or all subclasses thereof to produce a total effective funding to date; and
c. modeling the relationship between funding and condition to incorporate the said funding to date rather than only the funding in the current period;
wherein the model better reflects the contribution to the condition of the said class or subclass of improvements funded and performed in prior periods, to the degree to which funding from previous periods is summed effectively models the durability of the contribution of the improvement activities from previous funding, resulting in an improvement in the accuracy of the model with respect to different types of infrastructure articles, which can have benefits that range from ephemeral—which can be modeled with a durability factor of 0 for a benefit that has no carry-over from period to period—to very durable—which can be modeled with a durability factor of 1.0, if the benefits of the improvement activities less deterioration essentially carries over completely from time period to time period.

9. A method according to claim 1 further comprising the step of inputting a value of funds to be moved between classes or subclasses of infrastructure articles, wherein said input value of funds is expressed as an average funding change amount per period and is converted to an actual monetary change amount for each period over the time horizon of the analysis, in order to calculate appropriate actual monetary change amounts for each period when the input data table funding levels for each period may vary significantly from period to period, and further comprising the steps of:
a. calculating from the average funding change amount a change percentage that is to be applied to each period; and
b. multiplying said change percentage times the actual monetary amount in each period, to produce the actual monetary change amounts for each period to be moved between said classes or subclasses;
wherein the investment levels of each period can be adjusted proportionately, respecting the average monetary change amount specified by the user, while also applying an actual monetary change amount that is proportional to the actual monetary total amounts of each period, which may vary significantly.

10. A method according to claim 1 further comprising the step modeling the relationship between the costs and benefits associated with projects to improve the condition of the class or subclass of infrastructure articles as a non-linear curve, and further comprising the steps of:
a. representing the benefit associated with a given investment level by a first value and a second value, where said first value comprises an effective investment value and the said second value comprises the resulting condition score, both associated with the same set or subclass of asset items;
b. Producing a set of three or more pairs of values;
c. modeling, sufficiently well, a benefit/cost curve by a non-linear mathematical equation,
d. fitting said pairs to said equation, meaning that the equation parameters are calculated; and
e. calculating an expected benefit, in the form of a condition score, which can then be calculated from a given cost, in the form of an investment level;
wherein said relationship is modeled, allowing the calculation of an expected benefit, in the form of a condition score, and an incremental benefit/cost ratio, in the form of incremental condition divided by incremental investment, to be calculated from a given cost, in the form of an investment level.

11. An apparatus according to claim 1 and further comprising:
a. an overall configuration loading element which uses acceptable subclass identifiers for each subclass category, etc., reflecting the desires of the users for aspects such as colors, scales;
b. an input data loader element to load the data input files resulting from the infrastructure class management subsystems;
c. a modeling element which models the manner in which the condition of said classes of infrastructure articles are impacted by changes made to different funding parameters associated with the said classes of infrastructure articles;
d. a user variation element allowing a user to effect variations to one or more of a plurality of funding parameters;
e. a summarizing element to summarize the said expected results, transforming the scales to match the display scales expected by the user; and
f. a display responsive to said summaries of expected impacts to the user terms of condition of each asset class in graphical and tabular output formats permitting the user to select the most favorable set of funding parameter values;
wherein the user can use the selected set of said funding parameter values to determine the highest priorities of transformational activities to perform on each class of infrastructure articles, which will lead the maximum resulting conditions of the infrastructure articles overall.

12. An apparatus according to claim 11 further comprising a class-level and subclass-level funding parameter variation element leading to redistributing funding between classes and subclasses of infrastructure articles.

13. An apparatus according to claim 11 further comprising a user modifiable fiscal constraint parameter variation element to model changes to the economic situation in which the analysis is being performed, and wherein changing fiscal constraint parameters and further comprising:
a. an increasing or decreasing element to increase or decrease the inflation rate parameter and simulating the affect of that change in the calculations related to the funding for all classes and subclasses of infrastructure articles;
b. a growth rate simulation element simulating changes in the expected rate of growth in the funding available to each class of infrastructure articles based on the user increasing or decreasing the plurality of class-level funding growth rate parameters;
c. an inflation rate simulation element simulating changes to the effective unique inflation rate for each infrastructure class based on the decreasing the class-level funding growth rate parameters;
d. a funding availability simulation element simulating changes to the amounts of funding available to each class of infrastructure articles based on a user change to the class-level funding adjustment parameters, based on an annual average or specified by period.

14. An apparatus according to claim 11 further comprising a condition graph display element to display information to the user and wherein said display element comprises a time-based condition graph associated with a class of said infrastructure articles and/or one or more of a plurality of subclasses thereof, and further comprises:
a. a determination element to determine and set the time interval scale on one axis;
b. a determination element to determine and display an expected condition measure scale on the other axis; and
c. a calculation element to calculate and display a line graph showing the expected condition for each time period over the time horizon;
wherein the user can see the expected variation of said condition over time for the said class of infrastructure articles and/or said subclasses.

15. An apparatus according to claim 11 further comprising a benefit/cost display associated with a said class of infrastructure articles and/or one or more of a plurality of classes thereof, and further comprises:
a. a calculation element to calculate a line graph representing the shape of the benefit/cost curve for the said class of infrastructure articles and/or subclasses thereof;
b. a display to display said line graph;
c. a calculation element to calculate a point on that curve representing the amount of funding and resulting rolled up condition value for the said class of infrastructure articles or subclasses thereof;
d. a display to display said point;
e. a first derivative calculation element to calculate a quantity that is the first derivative of the benefit/cost curve at the funding level determined by the modification of one or more of a plurality of funding parameters for the said class of infrastructure articles and/or subclass thereof;
f. a determination element to determine the appropriate label indicating the units of the said number; and
g. a display element to display said quantity and label;
wherein the user can visualize the incremental improvement versus incremental funding level for the said class of infrastructure articles and/or said subclasses.

16. An apparatus according to claim 11 further comprising an indication element to indicate to the user if/when one or more of a plurality of changes made by the user to the funding parameters result in the funding for a class of infrastructure articles and/or any subclass thereof to go above a high funding level threshold or below a low funding level threshold, wherein results of the model become less accurate, said indication element, and further comprising:
a. a detection element to detect if one of the said high funding level thresholds or low funding level thresholds have been exceeded; and
b. a display to display the indication that the said high or low funding level threshold has been exceeded and to inform the user of class of infrastructure articles and/or subclass thereof for which the funding level threshold has been exceeded;
wherein the user can then either i) undo the most recent change of a funding parameter that caused the funding level threshold to be exceeded, or ii) make changes to other funding parameters that result in the problematic funding level to fall within the funding level thresholds.

17. An apparatus according to claim 11 further comprising an accuracy improvement element to improve the accuracy of the model that calculates the impact of improvement projects on the condition per the funding associated with the said class of infrastructure articles, or subclass thereof over time, and further comprising:
a. a loader element to load the weight associated with each row of data that is proportional to the significance of the infrastructure article that is the subject of that data row; and
b. an enhancement element enhance the calculation of the rollup of a plurality of data rows applies a weighted average calculation using the said weight of each row;
wherein the modeling of the infrastructure article condition incorporates an average that is weighted.

18. An apparatus according to claim 11 further comprising an improvement element to improve the accuracy of the model of the relationship between the funding applied to a class or subclass of infrastructure articles and the resulting changes in the condition of the said class or subclass, and wherein resulting changes in the condition of the said class or subclass comprise better reflection of the contribution to the condition of the said class or subclass of improvements made in prior periods, and further comprising;
a. a setting element to set a durability factor for each class or subclass of infrastructure articles;
b. an enhancement element to enhance rolling up the funding for the said class or subclass for a given time period to add also the rolled-up funding for the prior time period, zero for the first time period, multiplied by said durability factor, in the roll-up funding calculation for the class of infrastructure articles and/or all subclasses thereof to produce a total effective funding to date; and
c. an enhancement element to enhance modeling the relationship between funding and condition to incorporate the said funding to date rather than only the funding in the current period;
wherein the degree to which funding from previous periods is summed effectively models the durability of the contribution of the improvement activities from previous funding, resulting in an improvement in the accuracy of the model with respect to different types of infrastructure articles, which can have benefits that range from ephemeral—which can be modeled with a durability factor of 0 for a benefit that has no carry-over from period to period—to very durable—which can be modeled with a durability factor of 1, if the benefits of the improvement activities less deterioration essentially carries over completely from time period to time period.

19. An apparatus according to claim 9 and further comprising an input value converter that converts an input value of funds to be moved between classes or subclasses expressed as an average investment change amount per period, into a change percentage for each period over the time horizon of the analysis, in order to then calculate appropriate actual monetary change amounts for each period when the input funding levels for each period may vary significantly from period to period, and further comprising:
a. a percentage calculation element that performs a calculation to the average monetary change amount where it is divided by the average actual monetary total amount to produce a change percentage; and
b. a multiplying element which multiplies said change percentage times the actual monetary total amount in each period, to produce the actual monetary change amounts to be moved between the classes or subclasses for each period;
wherein investment levels of each period can be adjusted proportionately, respecting the average monetary change amount specified by the user, while also applying an actual monetary change amount that is proportional to the actual monetary total amounts of each period, which may vary significantly.

20. An apparatus according to claim 10 and further comprising an enhanced modeling element to model in a non-linear fashion the relationship between the costs and benefits associated with projects to improve the condition of a class or subclass of infrastructure articles and further comprising an average monetary change element and wherein said modeling element utilizes:
a. a pair of values, first one being the effective investment value and the second one being the resulting condition score, both associated with the same class and subclass of infrastructure articles, and representing the benefit associated with a given funding level;
b. a set of three or more pairs of values from the same class and subclass of infrastructure articles;
c. a non-linear mathematical equation that models sufficiently well a benefit/cost curve
d. a means of fitting said pairs to said equation, meaning to determine the parameters of the equation;
e. a means of calculating an expected benefit, in the form of a condition score, which can then be calculated from a given cost, in the form of an investment level;
whereby the said relationship is modeled, allowing the calculation of an expected benefit, in the form of a condition score, and an incremental benefit/cost ratio, in the form of incremental condition divided by incremental investment, to be calculated from a given cost, in the form of an investment level.
